(19) United States
(12) Patent Application Publication
(10) Pub. No.: US 2002/0163273 A1
(43) Pub. Date: Nov. 7, 2002

(54) Electric rotating field machine with a two-layered winding in the stator slots

(75) Inventor: Gerhard Huth, Leutershausen (DE)

Correspondence Address: Henry M. Feiereisen, Suite 3220, 350 Fifth Avenue, New York, NY, 10118, US

(73) Assignee: SIEMENS AKTIENGESELLSCHAFT, Munchen (DE)

(21) Appl. No.: 10/105,056

(22) Filed: Mar. 22, 2002

(30) Foreign Application Priority Data
Mar. 22, 2001 (DE) 101 14 014.2

(51) Int. Cl. H02K 3/00

(52) U.S. Cl. 310/184

(57) ABSTRACT

An electric three-phase induction machine with six poles and 15 stator slots and a two-layer winding scheme is described. The induction machine has a smaller overall size than conventional machines with a greater slot number, without degrading the efficiency and/or torque characteristic of the machine. The machine can be manufactured cost-effectively and is useful for applications with synchronous spindles in machine tools.

### CROSS-REFERENCES TO RELATED APPLICATIONS

This application claims the priority of German Patent Application Serial No. 101 14 014.2, filed Mar. 22, 2001, the subject matter of which is incorporated herein by reference.

### BACKGROUND OF THE INVENTION

The present invention relates to an electric three-phase AC machine with six-poles, and more particularly to a three-phase machine with a reduced number of poles that does not exhibit slot latching moments.

Electric rotating field machines, and more particularly three-phase AC induction machines, with six poles and a two-layered winding in the slots of the stator are known in the art. Such machines are preferably constructed with 36 stator slots regardless of the distance of the rotor shaft center from the periphery of the housing (shaft height) which essentially determines the overall size of the machine. This is particularly the case for permanent-magnet excited three-phase machines which are used as AC main motors/synchronous spindles in machine tools, in particular lathes. Three-phase AC induction machines are typically constructed as three-phase rotating field machines.

Electric rotating field machines with a small shaft height and N=36 slots disadvantageously also necessitate smaller dimensions of, for example, the inside diameter of the stator. A smaller inside diameter of the stator makes it increasingly difficult to manufacture the stator winding system, i.e., to machine the slots using automatic tools and to install the stator windings in the slots using automatic winding machines. This increases the complexity and cost of the manufacturing process. Moreover, a small slot pitch also causes a reduction in the slot fill factor, which makes inefficient use of the active elements of the machine and hence also reduces the torque efficiency. Attempts to increase in the slot fill factor for small slot dimensions increases the complexity of the manufacturing process which again reduces manufacturing throughput and increases manufacturing costs.

It would therefore be desirable and advantageous to provide a stator winding system for an electric machine, which obviates prior art shortcomings and which is compact in size and has a smaller shaft height than conventional electric rotating field machines, while still being reliable in operation and easy to manufacture in a more cost-effective way.

### SUMMARY OF THE INVENTION

According to one aspect of the invention, a six-pole electric rotating field machine includes a stator assembly, such as a laminated stator made from sheet metal, secured in a housing, and a rotor. The stator slots accommodate a two-layered winding with an upper layer winding and a lower layer winding. The number of the stator slots is less than 36, preferably 15.

By reducing the number of stator slots, the slot width can be made wider than that of a stator with a larger number of stator slots. The reduced number of slots and their improved spatial arrangement simplifies the winding process, in particular when using automated winding machines.

Larger, in particular wider, slots also increase the slot fill factor over that of conventional stator slots. Larger slots also provide a greater selection of wire sizes, in particular regarding the diameter and the permissible bending radius of the winding wires, as compared to electric three-phase machine with 36 stator slots. The greater selection of available wire sizes tends to be important also for the end windings.

The condition N=6·p·q for the number of slots, wherein N=number of slots, p=number of pole pairs, and q=number of slots per pole and strand, limits the number of possible embodiments with a symmetric design for three-strand windings for six-pole machines. If an acceptable harmonic characteristics is also desired, then the minimum number of stator slots is further limited to N=27.

Depending on the manner in which the electric rotating field machine is regulated and controlled, a highly symmetric design of the windings is most desirable. However, if a small winding asymmetry can be tolerated, then a winding with N=15 stator slots can be constructed which would still meet the requirements of many electric three-phase machines. As a result of the condition gcd (2p, N)=p, wherein “gcd” denotes the “greatest common denominator”, variations of the admittance with the slot frequency prevent the formation of slot latching moments. The active fractional skew factor should therefore be made equal to 0.5 slot pitch. The skew angle (slot skew) is then calculated by the following formula

$${γ}_{skew} = \frac{2 π}{2 * N} = \frac{360 °}{30} = 12 °$$

wherein γ_{skew} is the skew angle and N is the number of stator slots. The term “active fractional skew factor” refers to the skew of the stator slots in the section of the stator referred to as “active section”.

It is hence another advantageous feature of the winding system described herein that the harmonics of the winding corresponding to 5 pole pairs are eliminated entirely, because the corresponding winding factor is identical to zero.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a two-layered winding scheme for a stator of a three-phase electric induction machine with 15 slots, with the three phases U, V and W shown separately;

FIG. 2 is a sectional view of elements of a rotating field machine; and

FIG. 3 is a perspective view of a permanent magnet excited rotating field machine showing the slot skew γ.

### DETAILED DESCRIPTION OF PREFERRED EMBODIMENTS

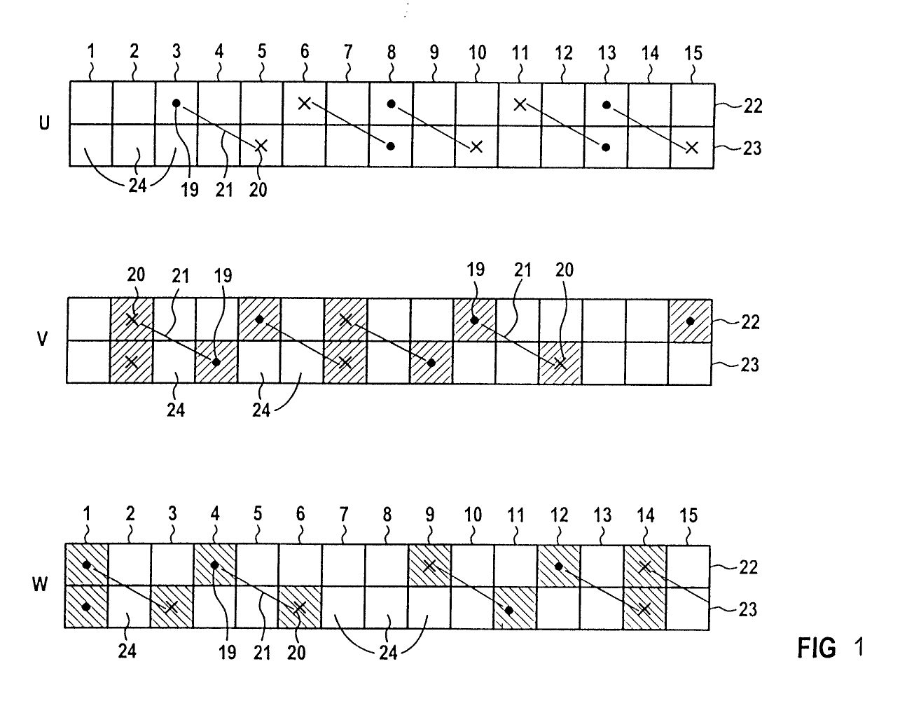

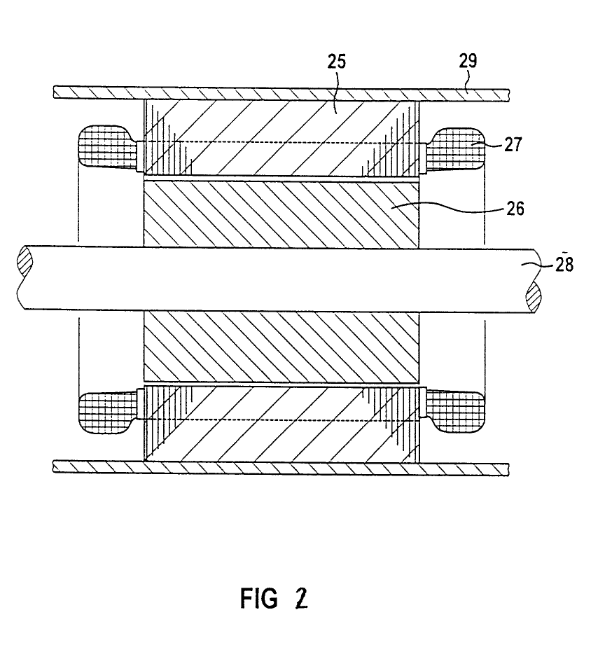

Turning now to the drawing, and in particular to FIG. 1, there is shown a schematic illustration of a two-layered winding scheme for a stator of a three-phase electric induction machine with 15 slots (not shown), which are labeled with the reference numerals 1 to 15. The two-layered winding has an upper layer 22 and a lower layer 23 which are disposed in the stator slots 1 to 15. The dots and crosses indicate in a conventional manner the winding direction and thereby also the direction (or phase) of the instantaneous current flow in the windings. For example, the conductor 20 of phase U goes into the plane of the figure, whereas conductor 19 exits from the plane of the figure, with the connection between the exiting conductor 19 and the entering conductor 20 being conventionally depicted by a loop 21. Herein, the loop 21 forms a section of an end winding (27 of FIG. 2).

An exemplary two-layered winding with the phase U includes conductors located in slots 3, 5, 6, 8, 10, 11, 13 and 15. For clarity, the strands for the phase U, the strands for the phase V and the strands for the phase W are shown separately in FIG. 1. However, as seen from FIG. 1, the empty fields 24 in the strands for each phase are occupied by strands from another phase, so that the windings fill all 15 slots of the stator.

FIG. 2 depicts schematically in cross section a motor 30 with a stator assembly 25, a rotor 26, a rotor shaft 28 and winding end turns 27, all of which are located inside a housing 29 of a rotating field machine. The rotor 26 can be a permanent-magnet excited rotor known in the art. The type of winding in the stator slots described above is preferably used in synchronous spindles employed in machine tools, wherein the rotor shaft 28 would drive the spindle.

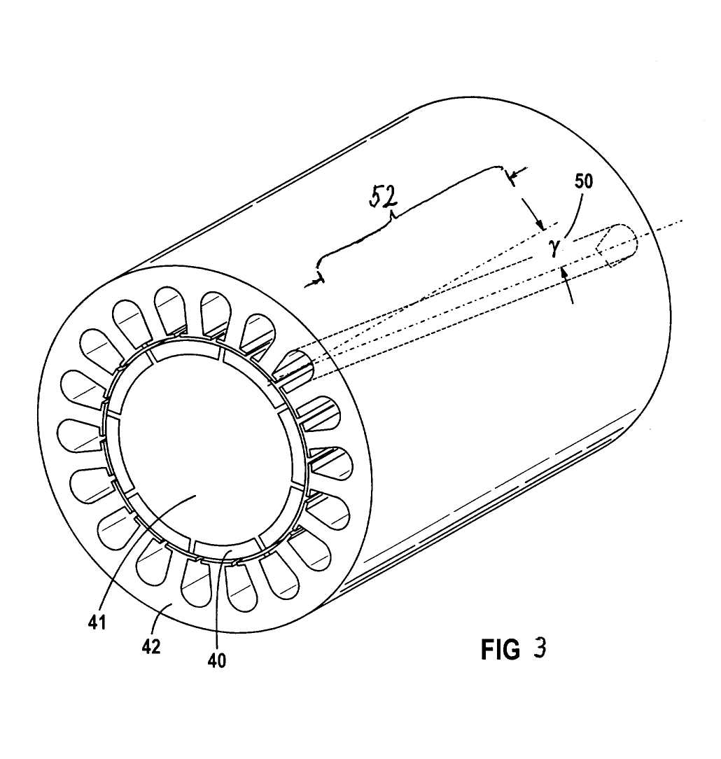

FIG. 3 is a perspective view of a permanent-magnet excited motor with a stator 42 and a rotor 41 with permanent magnets 40. Also shown is the skew angle 50 which denotes the angle γ subtended on the periphery of the stator in the axial direction between the longitudinal axis of the stator and the longitudinal direction of the stator slots. The reference numeral 52 indicates the length of the “active” section of the stator, over which the stator skew is effective in reducing torque latching.

While the invention has been illustrated and described as embodied in an electric rotating field machine with a two-layered winding in the stator slots, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An electric three-phase induction machine comprising:
a housing;
a stator assembly secured in the housing and having six poles and 15 stator slots, said stator assembly including a two-layered winding with an upper winding layer and a lower winding layer, and winding end turns located on end faces of the stator assembly, said end turns connecting strands of the upper winding layer with strands of the lower winding layer; and
a rotor supported in the housing for rotation relative to the stator.

2. The electric three-phase induction machine of claim 1, wherein the stator has an active section and wherein a slot skew of the active section of the stator is 0.5 times a slot pitch.

3. The electric three-phase induction machine of claim 1, wherein the electric three-phase induction machine is a permanent-magnet excited synchronous motor that drives a spindle.

4. The electric three-phase induction machine of claim 1, wherein the electric three-phase induction machine drives a machine tool.

5. The electric three-phase induction machine of claim 4, wherein the electric three-phase induction machine is incorporated in a machine tool.

6. The electric three-phase induction machine of claim 1, wherein a winding factor for a pole pair number 5p is identical to zero.
